(19) United States
(12) Patent Application Publication
(10) Pub. No.: US 2015/0262245 A1
(43) Pub. Date: Sep. 17, 2015

(54) COMPUTER IMPLEMENTED METHODS AND SYSTEMS FOR EXCHANGING DIGITAL OFFERS AND INFORMATION

(71) Applicant: NDOTO PTY LTD, Burnwood, NSW (AU)

(72) Inventor: Petros Arvanitis, Burwood (AU)

(73) Assignee: Ndoto Pty Ltd, Burwood (AU)

(21) Appl. No.: 14/433,292

(22) PCT Filed: Feb. 1, 2013
(86) PCT No.: PCT/IB2013/000352

§ 371 Date: Apr. 2, 2015

Related U.S. Application Data
(60) Provisional application No. 61/710,042, filed on Oct. 5, 2012.

(51) Int. Cl. G06Q 30/02

(52) U.S. Cl. CPC G06Q 30/0269; G06Q 30/0235; G06Q 30/0259; G06Q 30/0267; G06Q 30/0257

(57) ABSTRACT

A computer implemented method, a server, and a mobile device are used for exchanging digital offers, event invitations, and other information. The systems and methods leverage the ubiquity of client devices with software applications and location determination abilities to provide, request, etc. digital offers as well as bring users together for various events, activities, experiences, etc. The systems and methods provide a person to person, business to business, business to person, and person to business system allowing anyone (users, providers, etc.) to provide or request digital offers or to create events. The systems and methods further allow grace periods for soon to be expiring offers as well as abilities for users to leverage more users in gaining further discounts and rewards with various providers. Further, providers can specifically craft offers to users based on their profiles, location, social rank, etc.

### CROSS-REFERENCE TO RELATED APPLICATION(S)

The present application is a U.S. National Stage Entry Under 35 U.S.C. 371 of International Application PCT/IB2013/000352, filed on Feb. 1, 2013, and entitled “COMPUTER IMPLEMENTED METHODS AND SYSTEMS FOR EXCHANGING DIGITAL OFFERS BETWEEN USERS AND PROVIDERS THROUGH A DATA NETWORK,” which claims the benefit of priority under 35 U.S.C. 119(e) of U.S. Provisional Application 61/710,042, filed on Oct. 5, 2012, and entitled “COMPUTER IMPLEMENTED METHODS AND SYSTEMS FOR EXCHANGING DIGITAL OFFERS BETWEEN USERS AND PROVIDERS THROUGH A DATA NETWORK,” the contents of both of which are incorporated by reference herein.

### FIELD OF THE DISCLOSURE

The present disclosure relates generally to mobile device and networking systems and methods. More particularly, the present disclosure relates to computer implemented systems and methods for exchanging digital offers, event invitations, and other information via client devices and the like.

### BACKGROUND OF THE DISCLOSURE

The use of smart phones and mobile devices capable of accessing the Internet is growing at an exponential rate. Recent data shows that just over half of all mobile phones sold in the United States are smart phones capable of accessing the Internet. A majority of these phones include a global positioning system (GPS) sensor providing longitude and latitude data from satellites. Using this data, smart phones are capable of pinpointing a user's location accurately to within a few meters. The use of digital offers such as online coupons and promotions is a fast growing trend in the United States and throughout the world. The company Groupon which specializes in online digital offers and promotions reported close to 45% sales growth for the early quarters of 2012.

Several inventions are known in the field capitalizing on the strong growth in both smart phone sales and online digital offerings. For example, U.S. Pat. No. 6,996,579 discloses a method for groups of buyers to request a coupon from a seller. U.S. Pat. No. 8,103,519 discloses a method for business owners to transmit coupons to user cell phones. However, these inventions and many others like them fail to teach methods which allow a user or group of users to request or receive digital offerings from one or more sellers based on their unique profiles and physical locations. The prior art also does not teach a method which would allow a user or group of users to request an extension of time or “grace period” to redeem an offer which may be important if a user is not able to make it to a provider's location in enough time to redeem a time sensitive offer. Finally, the prior art does not teach a method which would allow a user or group of users to request an offering from providers located near them physically and allow providers to bid on, barter, or accept the offer.

### BRIEF SUMMARY OF THE DISCLOSURE

In an exemplary embodiment, a computer implemented method includes communicating, by a server, with a plurality of users including any of individuals or providers; maintaining a profile of each of the individuals including location information as reported to the server by a client device associated with each of the individuals and a profile for each of the providers; receiving a request from one of the individuals or the providers for a digital offer or event invitation, wherein the digital offer or event invitation includes a time limit; identifying associated individuals or providers for the digital offer or event invitation based on the profile associated with each and their associated location information; and providing the digital offer or event invitation to the identified associated individuals or providers.

In another exemplary embodiment, a server includes a network interface communicatively coupled to a plurality of users; a processor communicatively coupled to the network interface; and memory storing instructions that, when executed, cause the processor to perform the steps of: communicate, via the network interface, with a plurality of users including any of individuals or providers; maintain a profile of each of the individuals including location information as reported to the server by a client device associated with each of the individuals and a profile for each of the providers; receive a request from one of the individuals or the providers for a digital offer or event invitation, wherein the digital offer or event invitation includes a time limit; identify associated individuals or providers for the digital offer or event invitation based on the profile associated with each and their associated location information; and provide the digital offer or event invitation to the identified associated individuals or providers.

In yet another exemplary embodiment, a mobile device includes a network interface communicatively coupled to a server over a network; a location determination device configured to determine a physical location of the mobile device; a processor communicatively coupled to the network interface and the location determination device; and memory storing instructions that, when executed, cause the processor to perform the steps of: download and install an application from a server; periodically provide a location based on the location determination device to the server; provide a profile of an individual associated with the mobile device to the server; receive or request a digital offer or event invitation, wherein the digital offer or event invitation includes a time limit; redeem or accept the digital offer or event invitation; and request a grace period responsive to a time limit expiration.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a system for an exemplary operating environment of the computer implemented systems and methods;

FIG. 2 is a block diagram of an exemplary implementation of a server which may be utilized in the system of FIG. 1;

FIG. 3 is a block diagram of an exemplary implementation of a client device which may be utilized in the system of FIG. 1;

FIG. 4 is a flowchart of a grace period method for use in the system of FIG. 1;

FIG. 5 is a flowchart of a user generated offer method for use in the system of FIG. 1;

FIG. 6 is a of illustrates a fashion offer method; and

FIG. 7 is a flowchart of a friend socializer method.

### DETAILED DESCRIPTION OF THE DISCLOSURE

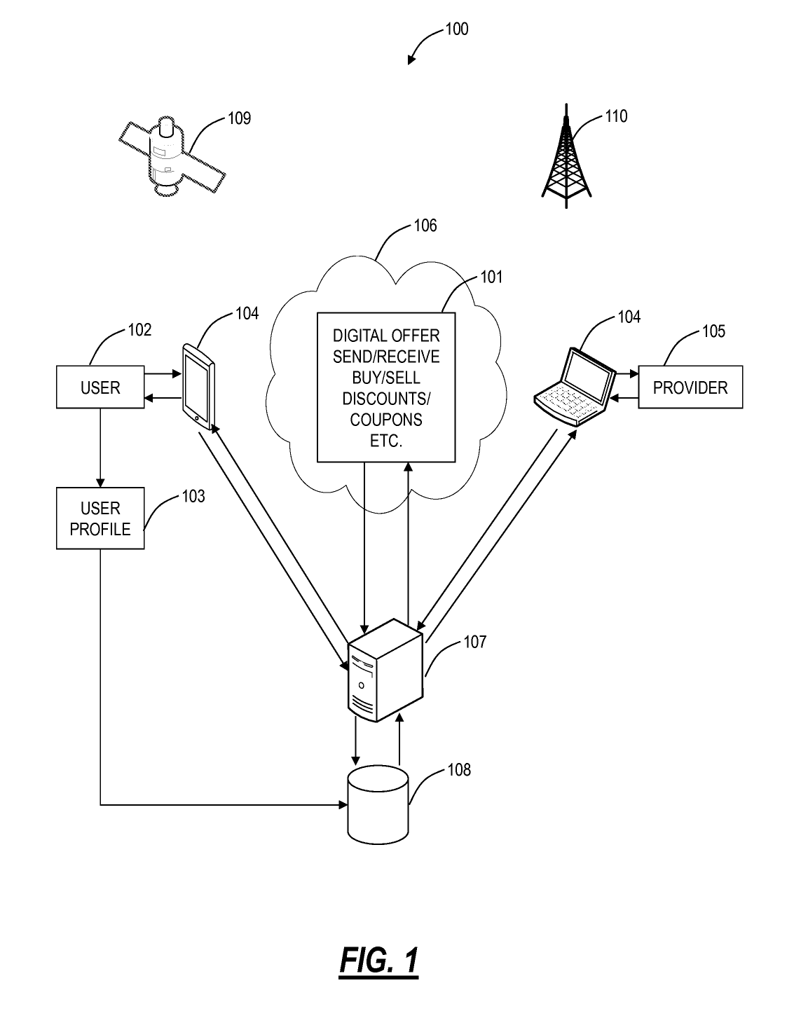

Referring to FIG. 1, in an exemplary embodiment, a network diagram illustrates a system 100 as an exemplary operating environment of the computer implemented systems and methods. The system 100 is configured to exchange digital offers 101 between users 102 with associated user profiles 103 and client devices 104 and providers 105 with corresponding client devices 104. The digital offer 101 can be anything including an offer to buy, sell, license, use, rent, etc. goods and/or services. The digital offer 101 also can be a discount, coupon, advertisement, or the like for the goods and/or services, i.e. any incentive regarding the goods and/or services. The digital offer 101 can also be any form of information of interest or relevance to the user 102. The digital offer 101 is exchanged on a data network 106 using one or more servers 107 which are communicatively coupled to a data store 108. Specifically, the client devices 104 and the one or more servers 107 are communicatively coupled there between via the data network 106. The data network 106 can include, without limitation, the Internet, a wireless network, a local area network (LAN), and the like as well as combinations thereof

The digital offer 101 may be sent to or requested by the user 102. In an exemplary embodiment, the user's 102 client device 104 can include a mobile device such as a smart phone, tablet, ultrabook, laptop, netbook, or any other digital device or emerging technology, etc. which includes an associated application “app” directed to accessing, requesting, etc. the digital offer 101. The user's 102 client device 104 can also include a radio configured to communicate on a wireless network 110 to access the data network 106. The provider 105 is generally a person, group, or business that is offering to sell goods and/or services. Alternatively, the provider 105 can also be another user 102 interested in exchanging information with other users 102 via digital offers 101. The provider 105 may at times send the digital offers 101 to the users 102, or, the provider 105 may even receive requests for offers from users 102 for the digital offers 101. The provider 105 may use a client device 104 to send a request to the server 107 through the data network 106 to provide the digital offer 101. In exemplary embodiments, the client device 104 is capable of receiving the digital offers 101 from the providers 105 based in part on their geographic location and their user profile 103.

The user 102 may be associated with a unique user profile 103 that can be stored in the data store 108 which may contain information about each user such as, without limitation, their age, gender, buying habits, education level, web browsing history, web search history, friends, contacts, employment, social status, online social profile (e.g. from a social network, etc.), location tracking, etc. Of note, the users 102 are registered with the system 100 and as part of an initial registration process, the users 102 can assist in creation of their user profile 103. Also, the user profile 103 can be updated over time based on preferences, activity, etc. Additionally, the user profile 103 may be anonymized as is described herein to protect the user's 102 privacy while concurrently allowing access to the digital offers 101. Specifically, with respect to an anonymized profile, the user profile 103 may present relevant, but non-identifying information to the providers 105. The user's 102 client device 104 can include a location determination device such as a GPS device capable of receiving latitude and longitude positions from a satellite 109. It is therefore possible for a provider 105 to send digital offers 101 to specific users or groups of users based in part on their user profile 103 and location. For example, the provider 105 may send the digital offer 101 to the users 102 within a set location who have previously purchased goods and/or services or who have searched for similar goods and/or services recently. It should be evident that there are multiple combinations and ways in which the system 100 can be used to send digital offers 101 to specific users 102 based on their location and/or user profile 103 information.

In exemplary embodiments, the system 100 allows the user 102 or group of users 102 to request or search for the digital offers 101 from the providers 105. For example, a user 102 may access their client device 104 which will access the server 107. The user's 102 client device 104 may run software which allows the user 102 to view providers 105 physically located near the user 102 (or within a specified distance from the user or from a set point such as zip code). For example, the user 102 may search for digital offers 101 from all coffee shops within a set location of that user's 102 location as determined by a GPS sensor or other mechanisms (e.g. by zip code) on the client device 104. Alternatively, the user 102 may configure (using software) their client device 104 to alert them when a digital offer 101 is sent out from the providers 105 that match preset criteria. For example, the user 102 may allow their client device 104 to give them an alert when the provider 105 located near them or matching their preset criteria sends out an associated digital offer 101. In an exemplary embodiment, the user 102 may set a location manually (e.g. by zip code, city, etc.) and search for or request to receive digital offers 101 from the providers 105 within a set radius or travel time from that location or who otherwise meet their preferences (e.g. only coffee shops or only offers for shoes).

In an exemplary embodiment, the system 100 can allow providers 105 to view and track the physical location of the users 102. For example, the providers 105 may view a display screen on their client device 104 that shows the users 102 located near them or traveling towards them. Of note, the users 102 can also be anonymized to protect privacy of the users 102. Using this exemplary embodiment, the providers 105 can customize the digital offers 101. For example, the providers 105 may see that users 102 are visiting their competition more frequently and send out a more aggressive digital offer 101 to attract more customers. In further exemplary embodiments, the system 100 includes automated methods and algorithms to track and even predict user 102 locations and directions and may automatically send out the digital offers 101 based on preset conditions set by the providers 105. This would be useful for providers who may be busy or short staffed and who do not have the time to personally monitor the location of users 102 on their client device 104. In exemplary embodiments, the digital offers 101 may have a time restriction set by the provider 105 or the system 100. The time restriction requires that the digital offer 101 be used by a certain date/time or within a certain timeframe after it was sent out or received by the user 102. Optionally, the system 100 provides a mechanism for the user 102 to request a time extension (sometimes called a “grace period”) which extends the amount of time the user 102 has to redeem the digital offer 101. In exemplary embodiments, the system 100 provides a mechanism for the user 102 to request digital offers 101 from or even barter with providers 105.

In an exemplary embodiment, the social or online profile of the user 102 may be used to influence the type of digital offer 101 which is sent to that specific user 102. For example, each user 102 may have a unique social rank which may be measured by their influence in social online media. There are multiple ways and computer implemented methods which can be used to calculate the user's 102 social rank. As a non-limiting example; a computer may be used to add the number of Facebook friends, Twitter followers, Linkedin connections, etc. associated with the user 102 to determine their social rank. In some embodiments, the system 100 uses social rank associated with each user 102 to determine the type of digital offer 101 which may be sent to that user 102. For example, the provider 105 may send out larger discounts (i.e. better offers) to users 102 who have higher social ranks in order to capitalize on their social influence. Additionally, the system 100 may allow providers 105 to give the users 102 digital offers 101 that can be improved (i.e. larger discounts) if that user 102 agrees to share information about the digital offer 101 or the provider 105 on their social network profiles. The extent of these better digital offers 101 may be different for each user 102 and dependent in-part based on their social rank.

In an exemplary embodiment, the users 102 may earn digital offers 101, points, cash, or otherwise rewarded (hereinafter “rewards”) for certain activities. Rewards can be tracked and linked to each user 102 using the system 100. For example, the user 102 may upload a video, text, or audio review of the provider 105 to earn rewards. The user 102 may link the review to their online social media profiles to earn additional rewards. In another example, the user 102 may use the system 100 to email their friends and contacts. The system 100 may then associate a user's 102 friends and contacts with that user 102. In exemplary embodiments, the system 100 and the providers 105 may use rewards and connections between the users 102 to increase their online marketing exposure and encourage business. For example, the provider 105 may offer a reward (e.g. free product or service) to the user 102 in exchange for that user sharing information about the provider 105 to their social network (e.g. Facebook friends). In exemplary embodiments, the user 102 may earn further rewards if one of their connections (e.g. Facebook friends) also conducts business with the provider 105. For example, the user 102 (first user) connected with another user 102 (second user) on the system 100 may earn rewards if the first user shares information online about the provider 105 and the second user purchases a good or service from the provider 105 within a set time period (e.g. 48 hours).

For example, the system 100 contemplates video snippet profiles where users can post information about themselves online such that other users or providers may view. This can also include static photos that play video when a mouse or other input device selects or moves over the photo. Also, users can upload photos or video snippets showing different facial expressions to their profile. The system 100 can use these images or videos throughout the system processes e.g. when good thing happen—happy face, when sad, sad face. This relates to social media friends dating etc. platforms applications. It gives users a visual on different sides of user, helps interaction, and makes it fun. The video snippets are there to show anything about the user and are not just limited to facial expressions. For example, the video snippets could be a user reading a poem, doing a review, cooking class, anything they want to share on their profiles so other users can see a bit more of them or a different side of them. The video snippets/photo expressions used by the system 100 on the user profiles 103 can be a series of videos/photos uploaded showing a series of facial expressions of user happy, sad, angry, neutral, frustrated, etc. which can be used throughout the system 100 and its processes, e.g. when good things happen, happy face, when bad things happen sad face, when it is a user's birthday it may show a happy face, or a sad face when no one has messaged them for their birthday. The user could set expression profile filters, settings for certain events, activities, dates, other users, chat sessions, web cams, meet ups but not limited to this. The video snippets/photo expressions can also be used for users to set profile moods daily or whenever they feel like it to show other users their mood for that day. It gives users a visual on different sides of user, helps interaction and also makes it fun. Users are able to leave short voice messages, notes, replies, and comments to other users or their own experiences, events, timelines, photos, videos, profile. It gives a different depth or dimension to interaction instead of just sending a written message or comment, note, etc.

In an exemplary embodiment, the system 100 provides a mechanism for a group of users 102 to organize and request the digital offer 101 from one or more providers 105. In this embodiment, the number (i.e. volume) of users 102 may influence the digital offer 101. For example, the provider 105 such as a restaurant may respond to a request from 5 users 102 with a price quote digital offer of $10 per meal while a request from 10 confirmed users 102 may be offered at $8 per meal. A reward may be given to the user 102 who organized the request for the digital offer 101. Alternatively, the social rank of each user 102 may also influence the offer 101 sent by the provider 105. In exemplary embodiments, the system 100 may provide a mechanism for the users 102 to vote on the digital offers 101 or the providers 105. For example, an organizer (i.e. a user who takes the lead in organizing the request for an offer) may suggest several providers 105 or several digital offers 101 and allow his friends or co-users 102 to vote on their preferred choice using their client devices 104 and the system 100. The system 100 can track and tally the votes and present all users 102 who voted with the results. Payments can also dictate votes and verification, and users of groups if are split or undecided can divide groups up into smaller ones and go their own ways creating divided smaller groups within one large original one.

In an exemplary embodiment, the system 100 may provide an online escrow type function wherein one or more users 102 may place in escrow money to help secure digital offers 101 from the provider 105. For example, a group of five users 102 using the system 100 may each place in escrow $10 for dinner which they have confirmed with a group organizer (i.e. a user who organized the request for an offer). This process may be made possible because the system 100 may have access to payment information (e.g. credit card data, PayPal account information, etc.) for users 102. The user 102 may simply use their client device 104 to authorize a charge or temporary hold for a set dollar amount. This money may be held in escrow by the system 100 and released to the provider 105 upon delivery of goods and/or services.

In exemplary embodiments, the system 100 of the present invention is capable of monitoring the user's 102 location by their client device 104. The system 100 may send the digital offer 101 to the user 102 based on the user 102 entering into or leaving a predetermined geographical location. For example, the client device 104 of the user 102 may periodically transmit to a server 107 the location of that device 104 and thus the user 102. The system 100 may use a rules engine to send corresponding digital offers 101. By way of example, the system 100 may send the digital offer 101 for a free cup of coffee to any user 102 who recently entered within 500 meters of the provider's 105 location.

In another exemplary embodiment, the system 100 may provide a mechanism for the user 102 to request a donation or sponsorship from the provider 105 or even other users 102. For example, the user 102 may be a non-profit organization and may request products, services, equipment, space, etc. from certain providers 105 located within a set distance from the user 102 or within a set distance from a point. Therefore, the system 100 allows the providers 105 or the users 102 to donate or sponsor offerings to users 102. As another example, the provider 105 may decide (based on a user's social rank or profile) to donate or sponsor to that user 102 a good or service. For instance, the JAVA Coffee shop may sponsor (i.e. donate) a free cup of coffee to all registered users 102 on the system 100 who have over 500 Facebook friends (or based on other factors) and the system 100 may communicate that sponsorship to Facebook to be posted on the user's 102 wall. The sponsorship can also be between businesses where businesses are able to sponsor other business events/activities/experiences/etc.

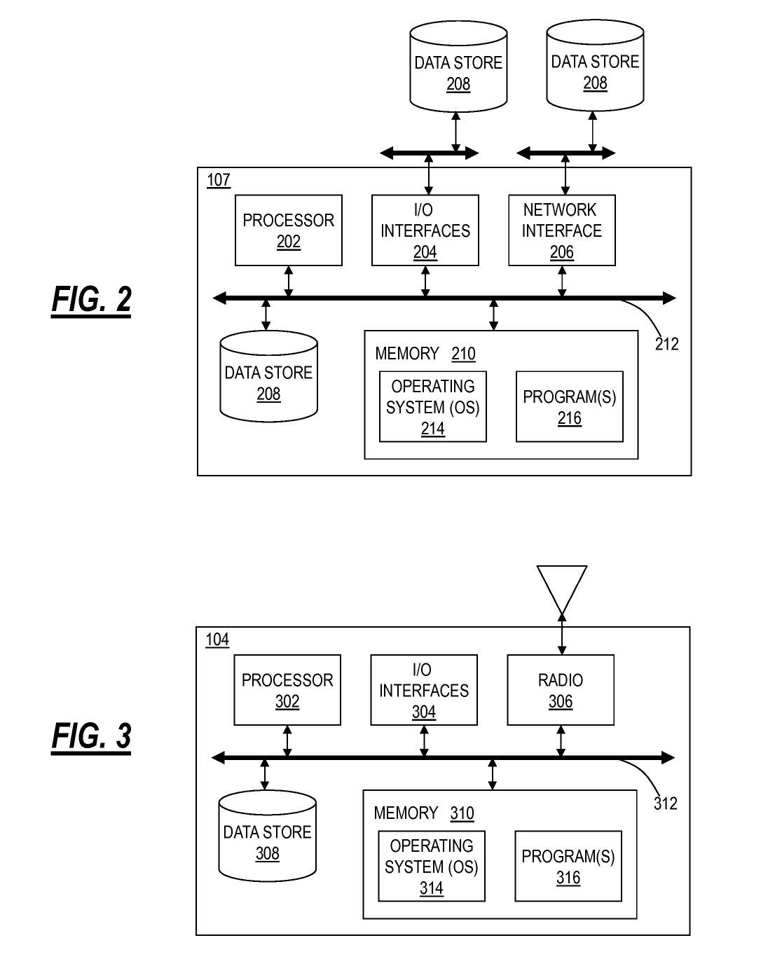

Referring to FIGS. 2 and 3, in an exemplary embodiment, a block diagram illustrates an exemplary implementation of a server 107 and a client device 104 which may be utilized in the system 100. The server 107 and the client device 104 may each be a digital computer that, in terms of hardware architecture, generally includes a processor 202, 302, input/output (I/O) interfaces 204, 304, a network interface 206 for the server 107, a radio 306 for the client device 104, a data store 208, 308, and memory 210, 310. It should be appreciated by those of ordinary skill in the art that FIGS. 2 and 3 depict the server 107 and the client device 104 in an oversimplified manner, and a practical embodiment may include additional components and suitably configured processing logic to support known or conventional operating features that are not described in detail herein. The components (202, 204, 206, 208, 210, 302, 304, 306, 308, 310) are communicatively coupled via a local interface 212, 312. The local interface 212, 312 may be, for example but not limited to, one or more buses or other wired or wireless connections, as is known in the art. The local interface 212, 312 may have additional elements, which are omitted for simplicity, such as controllers, buffers (caches), drivers, repeaters, and receivers, among many others, to enable communications. Further, the local interface 212, 312 may include address, control, and/or data connections to enable appropriate communications among the aforementioned components.

The processor 202, 302 is a hardware device for executing software instructions. The processor 202, 302 may be any custom made or commercially available processor, a central processing unit (CPU), an auxiliary processor among several processors associated with the server 107 and the client device 104, a semiconductor-based microprocessor (in the form of a microchip or chip set), or generally any device for executing software instructions. When the server 107 and the client device 104 is in operation, the processor 202, 302 is configured to execute software stored within the memory 210, 310, to communicate data to and from the memory 210, 310, and to generally control operations of the server 107 and the client device 104 pursuant to the software instructions. Note, the processor 310 may include a mobile-optimized architecture whereas the processor 210 may include a server-optimized architecture. The I/O interfaces 204, 304 may be used to receive user input from and/or for providing system output to one or more devices or components. User input may be provided via, for example, a keyboard, touch pad, stylus, voice commands, and/or a mouse. System output may be provided via a display device, audible indicia, and a printer (not shown). I/O interfaces 204, 304 can include, for example, a serial port, a parallel port, a small computer system interface (SCSI), an infrared (IR) interface, a radio frequency (RF) interface, a universal serial bus (USB) interface, and/or any proprietary interfaces (e.g. 19 pin or 30 pin connectors). The I/O interfaces 204, 304 can include a graphical user interface (GUI) that enable user interaction. Furthermore, the I/O interfaces 204, 304 may include a camera and/or video camera device.

The network interface 206 may be used to enable the server 107 to communicate on a network, such as the Internet and the like, etc. For example, the server 107 can utilize the network interface 206 to communicate to/from the plurality of users 102 and providers 105, etc. The network interface 206 may include, for example, an Ethernet card or adapter (e.g., 10BaseT, Fast Ethernet, Gigabit Ethernet) or a wireless local area network (WLAN) card or adapter (e.g., 802.11a/b/g/n). The network interface 206 may include address, control, and/or data connections to enable appropriate communications on the network. The radio 306 enables wireless communication for the client device 104. Any number of suitable wireless data communication protocols, techniques, or methodologies can be supported by the radio 16, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; GPS; and proprietary wireless data communication protocols such as variants of Wireless USB.

The data store 208, 308 may be used to store data. The data store 208, 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208, 308 may incorporate electronic, magnetic, optical, and/or other types of storage media. In one example, the data store 208 may be located internal to the server 107 such as, for example, an internal hard drive connected to the local interface 212 in the server 107. Additionally in another embodiment, the data store 208 may be located external to the server 107 such as, for example, an external hard drive connected to the I/O interfaces 204 (e.g., SCSI or USB connection). In a further embodiment, the data store 208 may be connected to the server 107 through a network, such as, for example, a network attached file server. The data store 208 can include the data store 108.

The memory 210, 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof Moreover, the memory 210, 310 may incorporate electronic, magnetic, optical, and/or other types of storage media. Note that the memory 210, 310 may have a distributed architecture, where various components are situated remotely from one another, but can be accessed by the processor 202, 302. The software in memory 210, 310 may include one or more software programs, each of which includes an ordered listing of executable instructions for implementing logical functions. The software in the memory 210, 310 includes a suitable operating system (O/S) 214, 314 and one or more programs 216, 316. The operating system 214, 314 essentially controls the execution of other computer programs, such as the one or more programs 216, 316, and provides scheduling, input-output control, file and data management, memory management, and communication control and related services. The programs 216 can include an application operating the system 100 on the server 107 and “apps” operating the system 100 on the client devices 104.

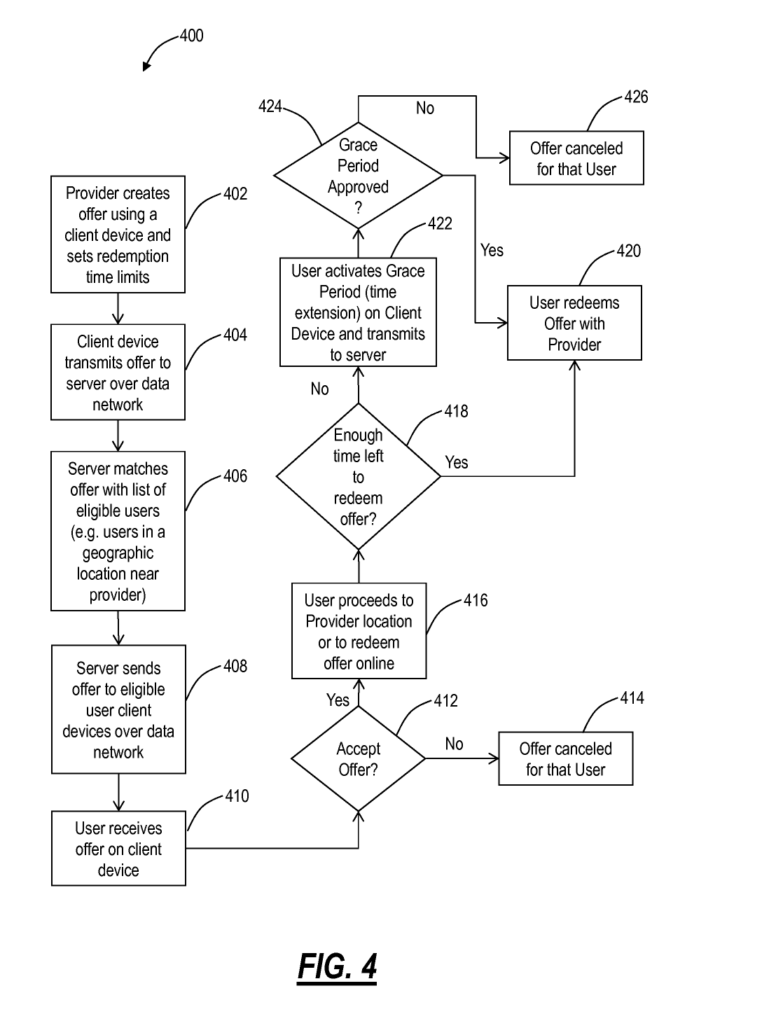

Referring to FIG. 4, in an exemplary embodiment, a flowchart illustrates a grace period method 400 for use in the system 100. In particular, the grace period method 400 can be implemented through a combination of the client devices 104 and the server 107 communicating via the data network 106. A provider creates an offer using an associated client device and sets redemption time limits (step 402). The client device of the provider transmits the offer to a server over a data network (step 404). The server matches the offer with a list of eligible users (step 406). For example, the eligible users may include users with their associated client devices in a geographic location near the provider. The server sends the offer to the eligible users' client devices over the data network (step 408). A particular user receives the offer on a client device (step 410). The user can accept the offer (step 412). If the user declines the offer (step 412), the offer is canceled for that user (step 414). If the user accepts the offer (step 412), the user proceeds to the provider location or redeems the offer online (step 416). Note, the user may wait to a time period to accept the offer. The method 400 checks if there is enough time left to redeem the offer (step 418). If so, the user redeems the offer with the provider (step 420). If the time period set by the provider has expired (step 418), the user can activate a grace period (time extension) function on the client device that transmits the request to the server (step 422). The provider is notified and can approve or deny the grace period (step 424). If the grace period is denied (step 424), the offer is canceled for that user (step 426). If the grace period is accepted, the user redeems the offer with the provider (step 420).

After a time critical offer has been accepted by a user(s) they may be able to use a Grace/verification function/feature which may enable them to tell the registered business that they are at location or very close proximity to location (physical address to where the offer is to be redeemed)—but not quite there for whatever reason. This function validates the offer and gives the user an extra window to redeem offer. This can also be part of terms of offer or if not the user can contact registered business and ask them for a grace code—coupon code to enter into the system to validate offer and get the extra time to redeem offer. For example, ABC Café posts a special offer to all users within 5 km of 2000 postcode for a half price lunch—with terms being it is valid only for 45 minutes from acceptance. A grace period is within terms so user(s) do not have to request grace code from ABC Café. User A has accepted offer and 45 minutes time validity has begun to redeem offer. User A's offer acceptance location was tagged via GPS system inbuilt into the system. User A has decided to catch the bus to the business location and the GPS locator shows the business and the user where they are located progressively. Unfortunately there has been an accident on route and the bus has come to a halt for 25 minutes. User A has only 10 minutes remaining to redeem offer or it may expire so decides to use the Grace function. User A activates grace function and system has extended offer validity for extra 30 minutes for User A. User A has arrived at location and redeems within the grace period.

The system 100 can include drive by/walk by/proximity/location based offers/deals—GPS or location defined—whereby users can be able to search or be alerted about events/activities/experiences that they can join or connect with that have yet to filled and/or have yet to filled and time is remaining till the event/activity/experience begins. So in this case users are not given a direct offer/deal but use their computer device, be it in car computer, smartphone etc. to search/or to connect with other users in the location or proximity/and/or distance they have set in the search function of the system to see what events/activities/experiences are available. This differs as they are not searching for offers/deals as such but looking at events/activities/experiences which they can join to connect with other like minded/compatible users. This can be for people to people, business to business, etc. For example, John can look in his car computer driving past the city and see any open events/activities/experiences within a particular location or radius of offers that are live, open, active, that have yet to fulfill quota of users etc. and that he would like to join. So they can come up with GPS locations of events/experiences/activities and time remaining till offers closed or till event/activity or experience starts etc. The offers and deals have already been generated by the system which the core users have already voted or accepted—so John in this example is not obtaining direct offers/deals but events/experiences/activities. This could be for any event/activity/experience/product/service. As location changes in car or on foot, new events can spring up or alert user of user can define search filters and decide what he/she/business wants to join or create event/activity/experience or users can also combine events/activities/experiences if similar or same in similar locations and not enough of a quota reached.

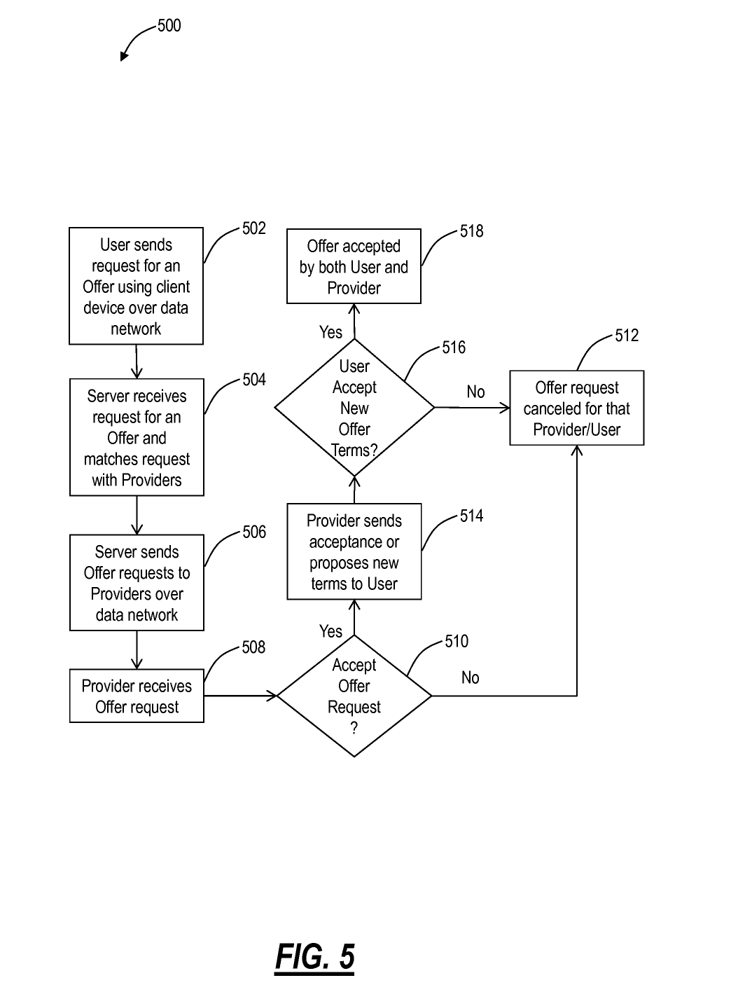

Referring to FIG. 5, in an exemplary embodiment, a flowchart illustrates a user generated offer method 500 for use in the system 100. In particular, the user generated offer method 500 can be implemented through a combination of the client devices 104 and the server 107 communicating via the data network 106. A user sends a request for an offer using a client device over a data network (step 502). A server receives the request for an offer and matches the request with various providers (step 504). The server sends the offer requests to providers over the data network (step 506). A provider receives the offer request (step 508). The provider may either accept or decline the offer request (step 510). The process can be manual or automated based on predetermined criteria. If the provider declines the request (step 510), the offer request is canceled for that provider and user (step 512). If the provider accepts the request (step 512), the provider sends an acceptance or even new terms to the user (e.g., a counter offer) (step 514). The user may either accept or decline the offer (step 516). If the user declines the offer (step 516), the offer request is canceled for that provider and user (step 512). If the user accepts the offer (step 516), the offer is accepted and acted upon by the user and the provider (step 518).

As an example to the method 500, the user 102 sends a request for digital offers 101 matching their preferences (e.g. coffee shops within 2000 meters). The provider 105 may (either manually or automatically based on preset instructions) accept the request from the user 102 or may send a counter offer (i.e. bartering). The user 102 may then either accept, decline, or counter that offer. Advantageously, the method 500 allows registered users to create/post a request for an offer so it can be viewed by registered businesses (the providers 105) on the system 100. These registered businesses may show their interest in being able to fulfill the product/service/activity requirements/objectives associated with the offer by either making a counter offer, donating an offer or to an offer, sponsoring an event, negotiating on an event and bartering with the users 102 to fulfill the request, and of course decline to make an offer on an event, i.e. do nothing. Bartering can also be between businesses where businesses can barter with other businesses on any product/service they like for value/credit/etc.

In an exemplary embodiment, the system 100 can utilize a user's social rank. A user's social profile rank may be made up of active connections with other users within the system 100 or another social network. The system may show the number of active connections in the user profile 103 and total reach and/or exposure the user has (e.g., social networks may have active connection with the subject system to allow and authorize data matching, integration and updating). The system may have a given formula of rating a user's social profile and strength and this may also be made visible to registered businesses thinking of making an offer on an event. Social profile rating or strength may be combined as total—breakdown available if desired—if more than one user(s) tagged to an event. Thus, users can use their social profile to negotiate on offers, get further discounts/savings, obtain event sponsorship. Businesses can opt to utilize a user's social profile to give discounts, negotiate on initial offers, sponsor an event. This may work by having terms within an offer for user(s) to allow automatic advertising posts on social networks showing active friends/followers that they accepted an offer from X00Y Business (Marketing XY Business).

Users may also be able to request or accept further discounts/savings on an offer by posting a video product, service, activity review. This can be streamed through the application and tagged to the businesses so other user(s) can view or uploaded to video sharing sites and other social video sites for view. A link to embedding video can also be part of the process. Users may be able to email friends through the system to receive further savings/discounts on an offer. The system may allow users to email friends—friends must validate email by clicking on it to open in a browser—this verifies user relationship—once validated points are passed to core user(s) for offer discount(s)/saving(s). Users can tag more users to an event or an offer if businesses allow it to increase savings/discounts of offer. If users or friends of users connect to a business because of core user activity the core user may get points/rewards added to their profile. For example, User A goes to ABC café and posts ad on a social network—user B (user A's friend) decides to go to ABC café and gets tagged there—points are rewarded to User A.

In an exemplary embodiment, the system 100 can support group offers. Here, offers require more than one user to post an event or be tagged to an event before posting on to the system 100. This allows users to post events/activities as a group, group event/activity. This allows registered businesses to make an offer, donate, sponsor, negotiate, bid, barter and/or sponsor an event. As this is a volume based event (more users/group of users) this increases the completion amongst businesses who would like to make an offer on an event. As these events have more than one user attached to them a voting system or designated core user feature/element may be used to ensure acceptance/confirmation of offer(s). When a registered business make an offer, the users to an event may receive notifications to vote on which offer(s) are best to shortlist—second round vote to get down to one single offer—if however user(s) have declined, the offer may be reworked and sent to business who made that offer to acknowledge if still valid with that number of user(s) attached to event/offer. If ok then offer sent back to remaining user(s) and accepted/confirmation sent. If core user designated to approve and accept events—then they may be able to confirm/shortlist and accept an offer on their own without all user(s) voting and confirming/accepting.

There may be a reward feature for organizing/core users to an event. This may work by how many user(s) are tagged or joined to an event. This means the business that has made an offer which has been accepted can offer a perk/gift to core user (organizing user) discount or savings on their individual product/service/activity price—for that core user. And if they can bring more approved user(s) to an event they can get more rewards/savings/discounts. A Booking Payment/Bond may be held in escrow for group events that have been accepted and confirmed—just in case of cancellations, no shows and changes. This bond may be released back to use once offer redeemed and confirmed by business and user(s). The system 100 can also be provider 105 to provider 105. That is, businesses can post events for business or other entities to make an offer on/join/sponsor/donate to/negotiate on/barter/bid on/tender. These event(s) may be the same as in the main process functions—for products, services and activities (including but not limited to wholesale and also manufacturing). Using the location tracking functionality of the client device, registered user(s) if/when walking by, driving by or passing by or within certain location proximity to registered businesses on the system can be alerted or prompted of certain offers by these businesses. Businesses may also see users in close proximity and send on the spot offers to attract customers or users to their place of business for their goods and/or services. Note, the location proximity can also be used for businesses to target other businesses.

In various exemplary embodiments, an objective of the system 100 and associated methods includes users meeting other users through the process of connecting through an event/activity/experience which is then fulfilled via offers/deals generated specifically for that event/activity/experience. The main process function here is that users connect with other users through an event/activity/experience. These events/activities/experiences are then fulfilled by the system 100 via an offer/deal feed which matches/generates offers/deals from suppliers/users to events/activities/experiences which users can accept/decline etc. This goes one step further then what is out there at the moment—it just does not list likes or interests it organizes it from start to finish. The system 100 can be people to people, business to business, business to people, etc. Of note, the system 100 seeks to organize events and the like for individuals to meet and participate. Individuals can meet friends online by creating an event, activity, experience be it an open event (which is open to all who want to join the event, experience, activity, etc. that they do not know) or a closed event (which is invite only—maybe for friends they already know) or a mixture of both depending on filters set. The user and/or collective users when an event has been filled or closed can be sent targeted offers targeted towards the event, activity, experience, etc. as per their filters, guidelines set. These will be fed through the system by registered or unregistered businesses, other users who can provide solution or fulfill, event, activity, experience.

Additionally, the system 100 can also tag users who want to go organize sub events/activities/experiences within an existing activity/experience/event—e.g. cinema is main event/experience—sub event created would be dinner or grabbing a coffee afterwards. Users who already know other users and not looking at making any new connections can also post events/experiences/activities on the system 100—tag other users and businesses, vice versa and generate offers/deals—organize an event/fulfilled by accepted offers and deals from system feed. Further, with respect to bidding on location based offers/deals, users can be sent an alert or message or view offers/tenders specific to an area which they can bid on—auction style—depending on their location, validity etc. Users can setup activities/experiences/events/product/service with a time duration—proposed future offers and plans—and allow offers to be generated in future depending on when savings/budget allocated to that event/experience/activity/product/service has been reached or when user wants. Offers/deals specifically related to the user activities/experiences/events/products/services can be generated before the proposed plan to entice user to accept if a significant saving can be made on similar/related objectives/requirements. In an exemplary embodiment, users can work to pay off offers/deals accepted through the system 100 for eligible offers/deals (supplier of offer must accept this payment type). So if deal accepted—they can do promotional work for the company/offer supplier until product/service/offer/deal is paid off.

The user generated offer method 500 also contemplates operation between businesses where businesses send out requirements (i.e., requests for offers) for product, services, activities, experiences, etc. to other business suppliers. For example, registered wholesaler businesses can use the system 100 to find businesses to target their product/services/etc. to. For example, a wholesaler of coffee can target cafes and send offers/deals to cafes. Business users can attract sponsorship or product/service value offers and deals from other businesses to fulfill events/experiences/etc. as well from the system 100. Further, business users can connect with other businesses through an activity/event/experience. Businesses can create an event/experience/activity and the system 100 can generate offers specific to event/activity/experience defined.

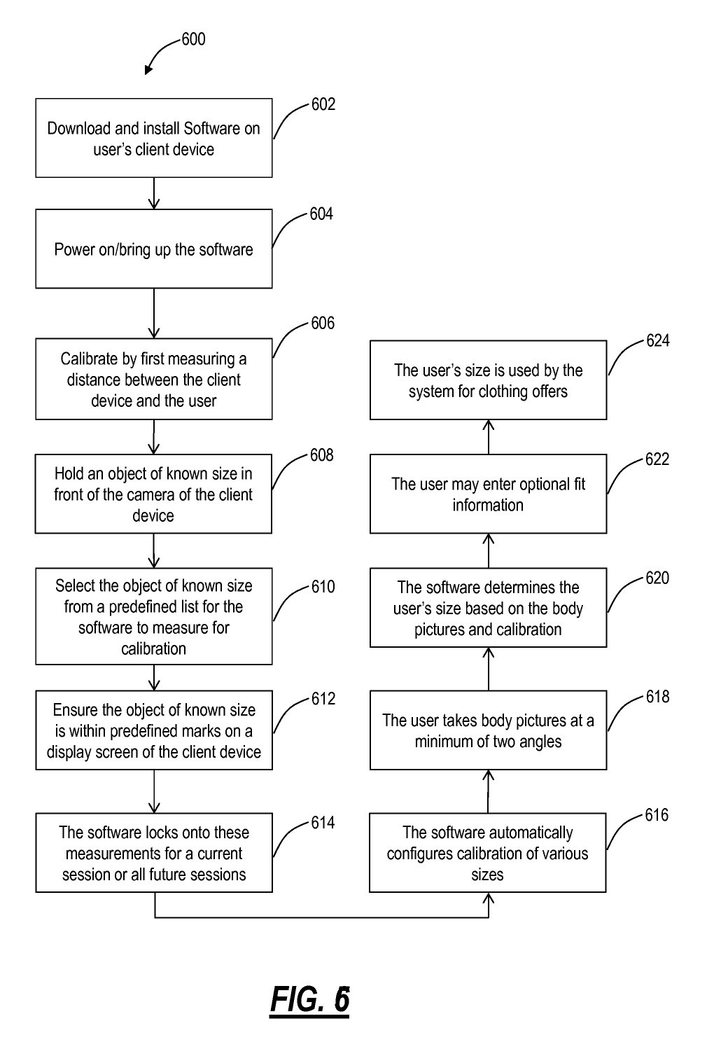

Referring to FIG. 6, in an exemplary embodiment, a flowchart illustrates a fashion offer method 600. With the method 600, users who request offers/deals specific to fashion, clothing, shoes, etc. can use their client device 104 camera to take their body measurements to tailor their clothing shopping experience. The software/app can allow one to capture their body measurements via the camera on their device whether this is a smart phone, tablet, PC or gaming console. As far as a smart phone is concerned, this is augmented reality. Advantageously, the client device 104 can help users to take body measurements/each body section to obtain more accurate sizing preferences which can be loaded into the system for each type of garment, shirt, pant, shoes, jacket, etc. and when users are looking for deals/offers on clothing, shoes, etc. the system 100 can automatically know if a certain garment fits the user or not based on their measurements and the size guidelines provided by the brand manufacturer/clothing retailer. The user can also filter results via brand, type, material, type of garment, retailer, etc. and the system can automatically load wardrobe offers that fit to user profile measurements, i.e. an online wardrobe of offers/deals specifically for users. Also, the system or user can create a template and upload to retailer clothing websites external to the system so it can match items of clothing fashion to his/her profile sizing.

The method 600 includes downloading and installing software on a user's client device 104 (step 602) along with powering on/bringing up the software (step 604). The software calibrates by first measuring a distance between the client device and the user (step 606). The user holds an object of known size in front of the camera of the client device (step 608). This allows the software and the client device 104 to measure accurately what it sees. The user selects the object of known size from a predefined list for the software to measure for calibration (step 610). For example, objects of known size can include, without limitation, an A4 sheet of paper, a $20 bill, a ruler with dimensions shown, etc. The user ensures the object of known size is within predefined marks on a display screen of the client device 104 (step 612). The software locks onto these measurements for a current session or for all future sessions (step 614). At this point, the software is calibrated. The user can then allow the software to automatically configure the calibration from this point i.e. shoulder width, leg length, etc. or they can assist by acknowledging and correcting the system by touching the screen and moving markers around—assuming the software is not accurate.

The user takes body pictures with the client device 104 at a minimum of two angles (step 618). Note, while two angles is a minimum, three would be better having front and side as the two main angles and a rear shot as the third. This accounts for different body sizes. The software determines the user's size based on the body pictures and calibration (step 620). Note, the pictures can be taken with clothing on or without. In the case without clothing, the software is explicitly configured to not provide images to any device outside of the client device 104. The user may optionally enter fit information and preferences (step 622). For example, the fit preferences can include tight, loose or comfortable fit, etc. The user's size may now be used by the system 100 for clothing offers (step 624). The user could create a wish list that they could forward on to friends and family—similar to a wedding gift register—eliminating returns for retailers and lost time and money in processing these. Targeted offers could come in to the device from “selected” retailers. Retail outlets could reduce the number of fitting rooms they have providing more floor room for merchandise assuming the fitting is very accurate.

The system 100 can also use the size measurements for wardrobe selection, advice, etc. Primary users who find someone to go on a date or meet with someone or group of people event and want advice, etc. can upload profile pictures or videos of wardrobe selections so other users can make selection, give advice, style council, review, as to what they should wear or maybe to ask their friends what to wear, other users vote on, etc. The system 100 can then offer users related style tips, clothing offers, advice, tags on brands, clothes styles, etc. will be used to determine offers.

In another exemplary embodiment, users can accept one deal and pay for that offer via bartering other offer/deals they have purchased or have for offer on the system 100—if both parties agree then barter payment can be used. This can be form of payment instead of cash or credit card. Users can pay with other offers/deals etc. Business users can market and target other users (business or consumer) specifically by doing a search on their profiles and matching terms, keywords and history of products services, activities, experiences, etc. to send out targeted offers/deals, samples, vouchers, promotions for a discount, free of charge specials, to gain exposure for marketing purposes. Users can borrow or apply for credit for certain products services and activities/experiences/events. This can be applied for within the system 100 or via other bank/credit institution offers/deals.

The system 100 can include flexible credit which is a new innovative type of personal credit option for users wanting to use credit to fulfill purchase/use/services activities experiences and events through the system 100. Commonly when someone wants to borrow/obtain credit they would approach a financial institution/bank and apply. In this approach, users can be able to obtain credit through the system 100 for payment of offers/deals products, services, etc. or request or search bank/credit institution credit deals to pay for other deals/offers within the system 100. One component of this innovative credit flexibility principal is allowing the borrower (user in this case) to make a variation on the loan post entering into the credit contract online with ease through the system 100.

For example, User A requests an offer to purchase a car through the offer system 100 and also requests to use a Flexi Credit Option through the system 100. User A needs $10,000 to purchase the car. User A wants to borrow $10,000 over 3 years. If User A went to ABC Bank a local bank—based on standard credit terms and checks User A would get approved for $10,000 for 3 years at 11% interest. This is normal standard personal loan terms—general amortization principle. Now as part of the flexibility system 100 product credit/loan, User A would request credit as part of his offer/deal acceptance through the system. User A's desired limit is $10,000 to pay for the car/purchase and nominates a five year term maximum as part of the credit policy and a rate range of between 8% to 15% interest. Now User A never asked for 5 years nor does User A want to pay 15%, User A wants the 8% offer. So the product facility approves User A at 8% for 3 years for $10,000 on a standard repayment option. This calculates and amortizes the loan over 3 years based on current rate and produces repayment schedule for John to pay amount every month.

Now the flexibility options available to User A if User A so wishes to initiate post getting the loan are: a no repayment option, a loan term extension option, financial product portability, referral credit, pay off incentives, etc. The no repayment option allows User A to pay back the total loan in full at any time—without worrying about any regular repayments as such. This can only be done if the loan term is within the maximum loan term of 5 years—in this example it is 3 years. This option calculates total interest component for the required loan $10,000 and a 3 year period at a rate of XY%, User A owes the bank $xyx in total interest. This can be paid back on day 1 or day 50 or day 1094. Now if the loan is paid back before the end of the loan term interest is recalculated and refunded back to the borrower. The Loan Term Extension Option allows User A to vary the term of the loan from a desired 3 years back to 1 year or 5 years through the system user profile. Now as User A varies the term of the loan, the repayment schedule and interest rate will then change. The system's credit service provider may offer a cheaper rate if the loan is paid back sooner or a higher rate if it is paid back later. The Financial Product Portability is the option of giving the borrower a portability function which allows the active personal loan to be rolled into another personal loan if another purchase is made through the offer/deal/event system. The Referral Credit is the option of giving the borrower the ability to pay off the loan by way of referring other customers and getting credit applied to their loan account. The Pay Off Incentives are the option of giving the borrower the ability to acquire points/credit to reduce their loan by way of completing surveys, making video reviews and sharing messages with their social profile. The system 100 will allow friends, family to make gifts, donate to or credit loan account—flexible.

Additionally, the system 100 can include a tier to online savings account linked to a user's profile. Here, users may set goals/objectives within the profile 103 and the user can select preferences for the system 100 to start generating offers straight away or when a budget or at a desired timeframe within the goal overall timeframe. The users can also elect to just have a tracking system online in the system 100 and save externally through other mechanisms and just periodically update what is saved towards the goal in lieu of an online savings account in the system 100 related to a specific goal/objective. Users may set any goals/objectives within their profile—these goals/objectives can be anything from a holiday to Bali, new car, new pair of shoes, new mobile phone, new bed etc. The system 100 can allow user to choose categories, specific terms, descriptions, tags, label filters and descriptions(for more accurate results) so goals/objectives are accurate and descriptive. Each goal or objective can be linked to an online savings account/account(s). The user can create a savings plan online through their profile and link it to a specific/purpose objective/goal and automatically put money/capital/cash towards the goal—money can be taken from a linked account, an internal online account created for that specific purpose goal/objective, through other payment methods, Paypal, credit card for example (or externally with only manual tracking towards goal through system). The system 100 allows the user to categorize, add tags, label, describe, filters to goals/objectives as it can use this information (anonymously) to notify third party suppliers/businesses/users registered to tender, bid, send offers through system to generate related/specific offers based on goals/objectives, to sponsor and or donate to, so user can either achieve goal/objective sooner than expected or for less (less than anticipated budget) saving them money. The user, after a fulfilled/goal objective, can review experience, add photos, videos etc. Social rank profile can also be used as bargaining negotiation or bartering tool. The goal/objective once accepted or reached can be automatically converted to event. The purpose of goal/objective can be a single or more than one user related event/activity/experience or for the purchase of goods/services small and large. The goal/objective can start out as a user wanting to create an event, or to purchase or use a product or service but they do not have the sufficient money for at the moment or want to budget and save for it for a desired time in future.

For example, User A creates a savings objective/goal—under category TRAVEL—now under this travel goal the system has attached an online savings credit account or user has opted to manually track saving towards this goal (keep external account). For this example, it is done through internal system online account for this specific goal/purpose. User A—call him John has set a limit or budget of $10,000 AUD and a timeframe of 12 months. He has picked Bali as the destination for 14 days and has included all other tags on where he wants to stay and descriptions, spending money, etc. goal and objective can be descriptive as possible, filters can be created and labeled so the system 100 knows the descriptions to easily match up with offers suppliers/businesses to generate offers, etc.—not limited to this though. After 6 months John has managed to save $6000 towards his goal to travel to Bali. He is not quite at $10,000 but the system 100 has already managed to create an offer for John from one of its third party suppliers, Flight Centre has anonymously been tracking Johns goal and has come up with an offer/deal for John. John received an offer alert from Flight Centre with an offer for $6,000 with travel, hotel, food, etc. to Bali for 14 nights with terms etc. The offer was just what John wanted and he can take a holiday 6 months earlier than expected and save $4,000. He accepts offer from Flight Centre and goal/objective reached—offer can be fulfilled paid accepted through system. All organized from step one being creation of goal/objective to payment to fulfillment. John can then review, post photos, videos of experience, etc. to his profile.

A goal or objective can also be created by a group of online users (more than one). This allows for an event/activity/experience/or the purchase of goods/services by more than one user to be created e.g. in the above case, a holiday event/experience by a group of users—this then allows the group to nominate travel destination, budget limit, timeframe tags, etc.—which they all agree on. If however the group has not saved for the event yet or they desire to save for it for a desired time in future they can add it to or make it a goal/objective. The system 100 can allow for a group online savings account to be created online attached or tagged to the specific/related event/product/service/activity/etc.—The system 100 creating an online saving goal/objective account can make it easier for users to track savings towards common goal/objective. This group savings account can allow users to track savings towards the common goal individually and as a group—who has paid and who has not. It eliminates the need to keep tabs on budgeting as the system 100 can do the work. The system 100 can automatically and anonymously track and generate offers for specific goals/objectives like so users can save and achieve goal quicker than anticipated to fulfill event or purchase of goods/services. Users can also be considered businesses who want to save for a particular goal/objective/product service/event/activity/experience/etc. The goals/objectives can also be reached by donations to a goal/objective/sponsorship to/bartering by/use of social rank profile, working for supplier of offer by way of promotion, or by using system credits if sufficient enough to offset cost of goal/objective—these system credits are obtained via surveys, referrals, affiliate offers (like purchasing goods/services from affiliated businesses stores etc. for example and credits given instead of discounts on items—which are then credited to a user account and can be used within the system 100 for this purpose but not just limited to this area of goals/objectives.

In an exemplary embodiment, Affiliate Company Product & Service Discounts can be part of the offer/deal system 100 which allow users/borrowers to shop at any affiliated store (business suppliers that can make offers/deals/events/activities for users within the system 100) and when they purchase an item from that connected store/retailer/user they will receive a discount on that item which will be applied to a loan/credit account as a principal reduction. An example would be User A's car loan of $10,000 through a flexi credit facility—User A goes on the system 100 and accepts an offer through an affiliated retailer—Sports B for example a clothing store. User A buys a shirt worth $100 and because it is an affiliated member the store gives User A 10% which equates to $10=this $10 is applied to User A's flexi loan as a reduction in principal. This can be done with any product, service, activity, experience, etc. provided by an affiliated company/supplier through the offer/deal/activity system feed. This means User A can keep buying and accepting offers/deals in the system 100 from participating retailers and redeeming discounts towards the loan as credit principle reductions thus paying the loan off without paying out of pocket necessarily. Affiliate offers and credits can also be applied to wish/wishlists, shopping tags, other offers, credit in account/profile to apply to whatever user desires within confines of system and to other affiliate connections outside of the system 100.

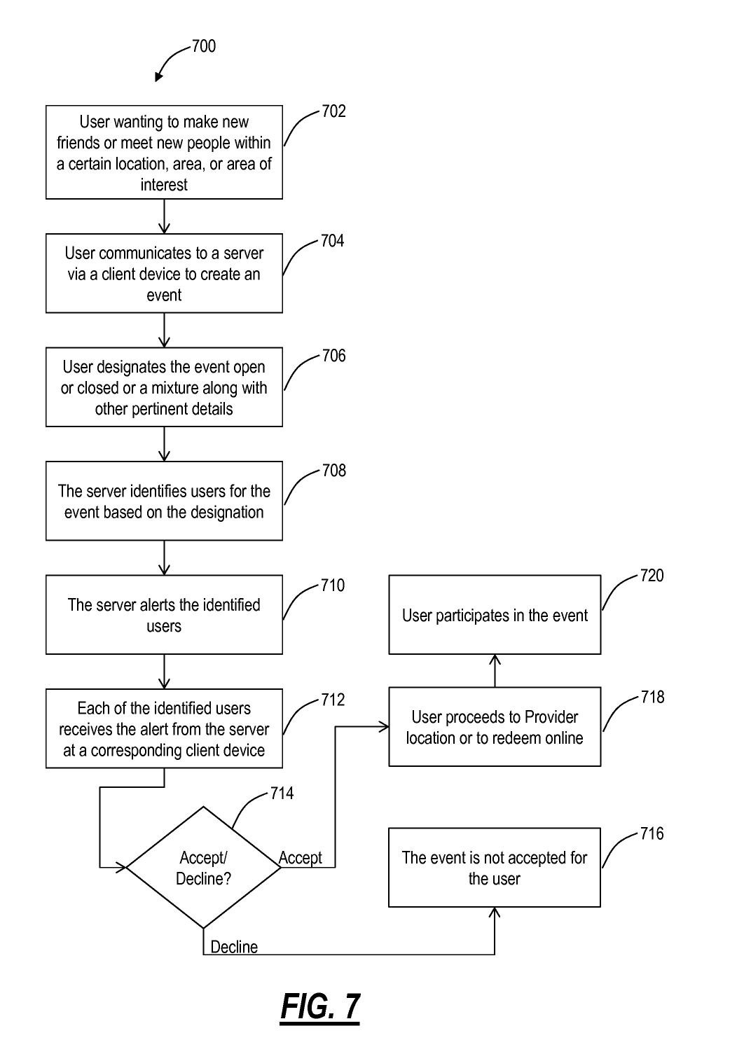

Referring to FIG. 7, in an exemplary embodiment, a flowchart illustrates a friend socializer method 700. The method 700 looks to a problem many people face today with the increasing use of technologies and social platforms, people still find themselves alone, with little or no friends, no close friends and not many people to hang out with and do things with. The problem addressed by the method 700 may not be a new one but the implementation and introduction of such emerging technologies and innovative social media communication platforms had an objective to fill and that was to bridge the communication gap between users. An example of this is a social network, e.g. Facebook, a user may have 300 friends and no active friends he/she actually sees, talks to or does things with. This is really 300 acquaintances not friends. This includes Twitter and other social networking sites that have only broadened user communication rather than strengthen it. Other than social media platforms, there are sites where people can meet people, chat to people, even date people online and offline but do they do not fill all the gaps. People can meet people online for all sorts of things, to become friends, to find a mate, to find a wife/husband, to find a partner, get event/activity/offers, etc. but these do not simultaneously assist in helping someone find a friend and join/create a desired activity/experience/event.

The method 700 provides a solution by assisting users to connect with other users, make friends, find friends, connect with existing friends/users with the intention/objective of joining or creating an activity/experience/event. The system 100 is all about making or connecting users with other users by way of doing something together—the connection is doing something together. This doing something together may be an activity/event/experience that is a common objective/goal/requirement of one or more user(s). That is, the offer in the system 100 may be an offer to join the activity/event/experience. The subject application is targeted towards both users who want to make new friends with the intention of doing something with them be it event/experience/activity. A secondary target market is users with existing friends who may want to do something with existing friends/and or meet some new people through the vehicle of an event/activity/experience. The events, offers, etc. associated with the method 700 can be anything from a coffee, a shopping spree, to a movie, dinner, skydiving, BBQ at someone's home, walk on the beach, holiday in the tropics, a trek in Peru or the Amazon. This could be really anything that can be classified as an event/activity/experience. Note, buying products and using services can also be classified as an event.

The method 700 begins with a user wanting to make new friends or meet new people within a certain location, area, or area of interest (step 702). This can also be wanting to meet existing friends, acquaintances, etc. The user communicates with a server via a client device to create an event (step 704). The event is used to refer to an event, experience, activity, etc.—anything that people can do together. This can include a commercial aspect as well—meeting at a restaurant, and this can be combined with the offers 101 described herein. The user designates the event open or closed or a mixture along with other pertinent details (step 706). Here, the user defines the event. Individuals can meet friends online by creating an event, activity, experience be it an open event (which is open to all who want to join the event, experience, activity, etc. that they do not know) or a closed event (which is invite only—maybe for friends they already know) or a mixture of both depending on filters set. The pertinent details can include day, time, location, attire, what to bring, etc. The pertinent details can also include the offers 101. For example, the user can create an event at a restaurant and concurrently request the offer 101 from the provider 105 of the restaurant—that is, a combination of the user generated offer method 500 and the friend socializer method 700.

The server identifies users for the event based on the designation (step 708). This can be identifying users based on invitation, location, mutual interest, mutual location, their associated user profile 103, and the like. The server alerts the identified users (step 710). This can include sending a notification to a client device for each of the identified users (e.g., pop up, text message, banner notification, email, etc.). Each of the identified users receives the alert from the server at their corresponding client device (step 712). Each user can accept or decline the event (step 714). If a user declines (step 714), the event is not accepted for that user (step 716). If the user accepts (step 714), the user proceeds to the provider location or redeems online (step 718) and the user participates in the event (step 718). The user and/or collective users when an event has been filled or closed can be sent targeted offers targeted towards the event, activity, experience as per their filters, guidelines set. These can be fed through the system 100 by registered or unregistered businesses, other users who can provide solution or fulfill, event, activity, experience.

For example, John Smith goes onto the system 100 to make some new friends and also find someone to watch the latest Bond Movie. He has no friends because he just moved to a new city. He hops online registers and starts looking for any events that match his requirements. He finds that there are a few active activities online that matches his requirements in and around where he lives but not watching Bond Movie. He joins that activity anyway which states 4 people open it reaches 4 people and the event is closed. The system 100 automatically when the event is filled starts sending offers to the user (moderator of the event) and other users to other related special offers for example popcorn $5 instead of $10 pre purchase etc. The system 100 can also look for similar offers in surrounding areas within location distance from target event location specified to see if they could save on other cinemas ticket costs—from other registered businesses on system being a cinema. The system 100 might find 25 km away cinema ABC is willing to offer $5 tickets instead of $20 person tickets. They can accept or decline by way of the moderator/core user/organizer or user vote.

John also decides to start his own event—Watch Movie—Open—10 people in the city within 20 km radius—offers accepted—he invites 4 of the people he met at last session which he got along with and also opens it to get other 6 places. He gets an offer from a Cinema stating if he gets 12 people then he can get a free ticket for himself as moderator and then get $5 off each ticket for friends. He accepts and ties in the offer with the event before it is closed and filled so people viewing can see it. It is filled and details of offer sent out to users accepted—paid with system. John has now been to two successful events and has made 10 new friends that all get along. The core user can also put a visible or invisible sub event to any event—core primary event—for example John may only want to go to dinner after the cinema session with 4 of 10 friends of primary event. The filters are set and offers come in for the dinner options available and pricing etc. Users can vote or core user can pick. Once set can be booked and finalized as a closed event. Also, sub events can be started by any user.

A friend radar can enable a search of users when moving around in an area or near an area that match compatibility with filters in the user profile 103 and show profiles of people you can connect with physically or through system. Affiliate Offers can be sent to user(s) in an event or activity—related offers. For example, with movies—affiliate offer could be for popcorn, ice cream, drinks. For dinner at a restaurant, an affiliate offer—bottle of wine from a store down the road before you go to dinner. For travel, an affiliate offer could be travel insurance, luggage, organizer activities sub activities in that area.

In another exemplary embodiment, the system 100 can support wish lists for the users 102. For example, User A really wants a pair of new shoes from a shoe store online. User A goes onto the application creates a wish, or wishlist. The system 100 allows User A to tag the product/service/event/activity whatever it is to her wishlist. It allows for links from source website and details, descriptions, etc. This tag is then saved to User A's profile. Items can also be manually inputted if items are not from online store or website. This allows users to add items/services/products/activities/travels, etc. from other sites, or manually inputted to show other users of their liking (e.g., open, closed, closed just for friends or others) to get donations, sponsorship for, to receive gifts from other users etc., or to save for, or for family users or friends to put money towards. In another exemplary embodiment, an event can be booking a hotel or meeting room for a meet up, etc. This can include short stay hotel offers, i.e. not overnight. The system 100 can feed offers and deals for hotels/motels/places to stay either as a request from user(s) or as an promotion based on locations and preferences of users—short stay offers/deals—1 hour to 8 hours for example.

In still another exemplary embodiment, the system 100 can rank users based on dating spending habits. This can be called a “Dutch Meter” from the expression going Dutch being both users pay their way for a dinner or a date. This ranking system can incorporate past spending habits recorded on the system 100 via users themselves or other user reviews or ratings that they had been on dates, meets with and shows a rating say out of 0 to 10 as to where the user sits in terms of being Dutch. A rating of 10 might be they expect the other user to pay for everything and a rating of 0 being they always pay or insist to pay for example and 5 being they prefer going 50/50 with bills for example. The system 100 may also have other ranks meters but not limited to, the gifts the user buys for other users, offers they accept or purchase through system, donations they make, etc. It could split the rating into different rating meters. For example, one being Dutch Meter, another being Charitable Rating Meter etc. Rating meters can be kept anonymous, open, closed, viewed by who the user prefers. Users can set the preference and filters.

Additionally, the system 100 can alert or message users if default user location has changed (depending on filters set—state, suburb or country). If set to default being country then system can automatically pickup by way of activity, interaction on system of GPS location, message server locations etc. where user is and alert them if they have in fact changed locations in this example countries and whether they would like to set new default location. An example would be John goes to New York for a holiday, the system 100 picks up his new GPS location and alerts John whether he would like to change default location on profile to America, New York for example and the purpose, be it relocation, travel, business trip, etc. but not limited to these things. John or any user may also manually change default location. Also, the system 100 can ask John/User how long he intends to stay in the new location or how long to keep this default location for or to just leave it to default system settings until a new GPS location or country is found to keep alerting him to change location on profile, e.g. so if John comes back from his New York holiday after 10 days, the system 100 can automatically alert to change default location again back to Australia for example or for User to manually change back. The system 100 can also alert the user if they now would like to proceed with obtaining local offers or to view location based profiles/users/events/offers/etc. as default locations changed.

Further, the system 100 can provide foreign currency conversion based on location such as tied to the above. As described herein, the system 100 can allow users to open or attach an online deposit/savings account to their profile. The system 100 can allow users to preload/deposit to cash denominated into any base currency. The user, upon loading the account, can be depositing in their location based currency or from a list of currencies (default can be location based—location Australia—AUD). This base currency can follow their profile location by default. If for example the system 100 picks up that the user is travelling to America from Australia and default location changed (process as per above location swap) it can also prompt the user if they wish to switch the currency denomination to USD from AUD, for example. It allows for easy conversion and switches and also this could be done manually by the user at any time. The user can now join or pay for offers that they receive locally through the system in the correct denominated currency.

In another exemplary embodiment, the system 100 does not only allow users to make friends, go on dates, meets, join or create events but also search for other users for the purpose of travelling together (this is also considered an event). This allows for compatibility checks, profile tag matches etc. The system 100 can allow users to search for travel buddies in any location or default locations for a specific travel event or holiday. As a sub process, if the user changes default location and sets filters in profile on system to be visible or labeled for example as Travelling/On Holiday/Tourist status per say, the system 100 can make them visible to people that are also tourists or travelling to that part of the world/travelled to that part of the world, and they can swap, see other travelling user profiles, see related events/offers activities etc. It gives users the ability to meet up with other users who are travelling—so they can maybe become travelling buddies or to experience a bit of what they miss at home by seeing someone else from Australia that is travelling America. The system 100 can allow businesses and other users open/closed to see this type of status on profile depending on filters, preferences set by user. This sub process also allows user to create/join events/etc. to get specific related offers from location based suppliers/businesses/etc. to meet or make friends or even date or experience something with someone or a group of people travelling to, or who are in a different country triggered by location based on status of user and/or default location change and user confirmations/preferences etc.

In yet another exemplary embodiment, the system 100 can allow users to interact with other users in a totally new way. This can be labeled as a physical gift for example. It may include, without limitation, a physical kiss, hug, dance, song, and comedy act. For example, John meets Sarah online and they become friends. John lives in NSW and Sarah in Victoria which are two different states. Sarah just got promoted at work and because John works himself and cannot drop everything and go to Sarah's work to surprise her, he decides to do something different—send a physical gift. He decides to surprise Sarah with a physical gift—hug for Sarah—this can be done through an external supplier who is employed by system application company to do this (filters and advanced settings can be set by type of person they would like to send to recipient of surprise, looks, wardrobe, gender, sex, color hair etc. or if John has a connection with one of Sarah's friends on the system that lives near Sarah he can request a physical gift to her friends in this example to fulfill the surprise. Sarah's friend Anne for example is a mutual friend and lives near Sarah so John decides to fulfill the physical gift through Anne, which she accepts. Sarah gets a big hug from Anne on behalf of John. The physical gift can also be anything really for example also a stripper for a stag party organized as a physical gift, a comedy act for a laugh, a song or poem sung or spoken to someone for a proposal. Anything can be outsourced. The system will allow internal offers to be generated from filters, search, type of gift, etc. and requirements/desires or if cannot be fulfilled by system can be organized manually from external sources.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A computer implemented method, comprising:
communicating, by a server, with a plurality of users comprising any of individuals or providers;
maintaining a profile of each of the individuals comprising location information as reported to the server by a client device associated with each of the individuals and a profile for each of the providers;
receiving a request from one of the individuals or the providers for a digital offer or event invitation, wherein the digital offer or event invitation comprises a time limit;
identifying associated individuals or providers for the digital offer or event invitation based on the profile associated with each and their associated location information; and
providing the digital offer or event invitation to the identified associated individuals or providers.

2. The computer implemented method of claim 1, wherein the digital offer or event invitation comprises a digital offer from a provider to an individual, and further comprising:
receiving an acceptable of the digital offer by the individual;
receiving a notification that the individual needs a grace period for the time limit of the digital offer;
notifying the provider of the grace period; and
performing one of providing the grace period to the individual and canceling the offer based on a response to the grace period from the provider.

3. The computer implemented method of claim 2, wherein the response to the grace period comprises an automated response to a predetermined time period based on a setting in the profile of the provider.

4. The computer implemented method of claim 1, further comprising:
displaying any individuals within a predetermined location of a provider, wherein the individuals are anonymized to the provider; and
receiving a request from the provider to send a digital offer to the individuals within the predetermined location.

5. The computer implemented method of claim 4, wherein the request is automatically provided from the provider based on predetermined criteria comprising at least a number of the individuals within the predetermined location of the provider.

6. The computer implemented method of claim 1, further comprising:
monitoring a location of an individual based on their associated client device; and
providing alerts to the individual of any digital offer or event invitations based on the location of the individual.

7. The computer implemented method of claim 1, wherein the digital offer or event invitation comprises a digital offer from a provider to an individual, and further comprising:
providing the digital offer to the individual based on a social rank of the individual, wherein the digital offer comprises more incentives for a higher social rank.

8. The computer implemented method of claim 7, further comprising:
increasing incentives associated with the digital offer based on the user performing various tasks associated with a social network and connections associated therewith.

9. The computer implemented method of claim 1, wherein the digital offer or event invitation comprises a digital offer request from an individual to a provider, and further comprising:
receiving a response from the provider to the digital offer request;
providing one of an acceptance and a counter offer to the individual based on the response.

10. The computer implemented method of claim 9, further comprising:
posting an event from the individual to a plurality of additional individuals, wherein the event relates to the digital offer request;
receiving acceptances from some of the plurality of additional individuals; and
providing the acceptances to the provider for consideration regarding the response thereto.

11. The computer implemented method of claim 10, further comprising:
responsive to posting the event, determining the plurality of additional individuals based on an event status and an associated profile of each of the plurality of additional individuals; and
notifying each of the determined plurality of additional individuals.

12. The computer implemented method of claim 10, further comprising:
providing affiliated digital offers to the individual and the plurality of additional individuals based on the event.

13. The computer implemented method of claim 1, further comprising:
sending software to a client device of an individual for calibration and measurement of the individual, wherein the calibration and measurement is performed locally by the individual and comprises the steps of:
taking an image of an object of known size, wherein the object of known size is input by the individual;
determining a distance from the client device to the individual;
taking at least two angled images of the individual; and
determining sizes of the individual based thereon.

14. The computer implemented method of claim 13, further comprising:
storing the sizes of the individual in an associated profile; and
providing the sizes to various providers for digital offers associated with fashion.

15. The computer implemented method of claim 1, further comprising:
maintaining a financing account for an individual to purchase an item from a provider; and
adjusting the financing account based on activity of the individual with the provider and a plurality of additional providers.

16. The computer implemented method of claim 1, further comprising:
displaying, to an individual, a plurality of additional individuals within a predetermined location of the individual based on each associated client device, wherein the plurality of additional individuals are filtered based on criteria and their associated profiles.

17. A server, comprising:
a network interface communicatively coupled to a plurality of users;
a processor communicatively coupled to the network interface; and
memory storing instructions that, when executed, cause the processor to perform the steps of:
communicate, via the network interface, with a plurality of users comprising any of individuals or providers;
maintain a profile of each of the individuals comprising location information as reported to the server by a client device associated with each of the individuals and a profile for each of the providers;
receive a request from one of the individuals or the providers for a digital offer or event invitation, wherein the digital offer or event invitation comprises a time limit;
identify associated individuals or providers for the digital offer or event invitation based on the profile associated with each and their associated location information; and
provide the digital offer or event invitation to the identified associated individuals or providers.

18. A mobile device, comprising:
a network interface communicatively coupled to a server over a network;
a location determination device configured to determine a physical location of the mobile device;
a processor communicatively coupled to the network interface and the location determination device; and
memory storing instructions that, when executed, cause the processor to perform the steps of:
download and install an application from a server;
periodically provide a location based on the location determination device to the server;
provide a profile of an individual associated with the mobile device to the server;
receive or request a digital offer or event invitation, wherein the digital offer or event invitation comprises a time limit;
redeem or accept the digital offer or event invitation; and
request a grace period responsive to a time limit expiration.
